(19) United States
(12) Patent Application Publication
(10) Pub. No.: US 2014/0173306 A1
(43) Pub. Date: Jun. 19, 2014

(54) SYSTEM AND METHOD FOR PROVIDING FOR POWER SAVINGS IN A PROCESSOR ENVIRONMENT

(71) Applicants: Barnes Cooper, Tigard, OR (US); Faraz Siddiqi, Portland, OR (US); Justin Perrenoud, Kaysville, UT (US); Ping She, Chandler, AZ (US); Claes Olsson, Phoenix, AZ (US); Assar Badri, Chandler, AZ (US); Benjamin Clark, Queen Creek, AZ (US)

(72) Inventors: Barnes Cooper, Tigard, OR (US); Faraz Siddiqi, Portland, OR (US); Justin Perrenoud, Kaysville, UT (US); Ping She, Chandler, AZ (US); Claes Olsson, Phoenix, AZ (US); Assar Badri, Chandler, AZ (US); Benjamin Clark, Queen Creek, AZ (US)

(21) Appl. No.: 13/719,296

(22) Filed: Dec. 19, 2012

(51) Int. Cl. G06F 1/32

(52) U.S. Cl. CPC G06F 1/32
USPC 713/320

(57) ABSTRACT

Particular embodiments described herein can offer a method that includes receiving storage operation information that is to indicate one or more storage drive operations, receiving storage independent power information, determining, by a processor, a performance profile based at least in part on the storage operation information and the storage independent power information, and causing a setting of at least one power management directive that is to correspond with the performance profile.

### TECHNICAL FIELD

Embodiments described herein generally relate to providing for power savings in a processor environment.

### BACKGROUND

As electronic devices become more complex and more ubiquitous in the everyday lives of users, more and more diverse requirements are placed upon them. For example, many electronic devices can operate on battery power, thus allowing users to operate these devices in many different circumstances. In addition, as capabilities of electronic devices become more extensive, many users may become reliant on the enhanced performance such capabilities provide. As these aspects of electronic devices have evolved, there has become an increasing need for power optimization so that users may enjoy longer battery life. However, under many circumstances, power optimization may sacrifice performance. Therefore, it will be highly beneficial for a user to be able to have the desired performance when it matters the most to them, and to have power optimization during circumstances where performance may be less important to them.

### BRIEF DESCRIPTION OF THE DRAWINGS

Embodiments are illustrated by way of example and not by way of limitation in the FIGURES of the accompanying drawings, in which like references indicate similar elements and in which:

FIG. 1A is a table illustrating processor power states according to at least one example embodiment;

FIG. 1B is a table illustrating sleep power states according to at least one example embodiment;

FIG. 2 is a block diagram illustrating software component interaction according to at least one example embodiment;

FIGS. 3A and 3B are diagrams illustrating examples of performance profiles;

FIG. 4 is a diagram illustrating an example user interface for setting storage independent power information according to at least one example embodiment;

FIG. 5 is a flow diagram showing a set of operations for providing for power savings according to at least one example embodiment;

FIG. 6 is another flow diagram showing a set of operations for providing for power savings according to at least one example embodiment;

FIG. 7 is a simplified block diagram associated with an example ARM ecosystem system on chip (SOC) of the present disclosure; and

FIG. 8 is a simplified block diagram illustrating example logic that may be used to execute activities associated with the present disclosure.

The FIGURES of the drawings are not necessarily drawn to scale or proportion, as their dimensions, arrangements, and specifications can be varied considerably without departing from the scope of the present disclosure.

### DETAILED DESCRIPTION OF EXAMPLE EMBODIMENTS

The following detailed description sets forth example embodiments of apparatuses, methods, and systems relating to providing a power savings in a processor environment. Features such as structure(s), function(s), and/or characteristic(s), for example, are described with reference to one embodiment as a matter of convenience; various embodiments may be implemented with any suitable one or more of the described features.

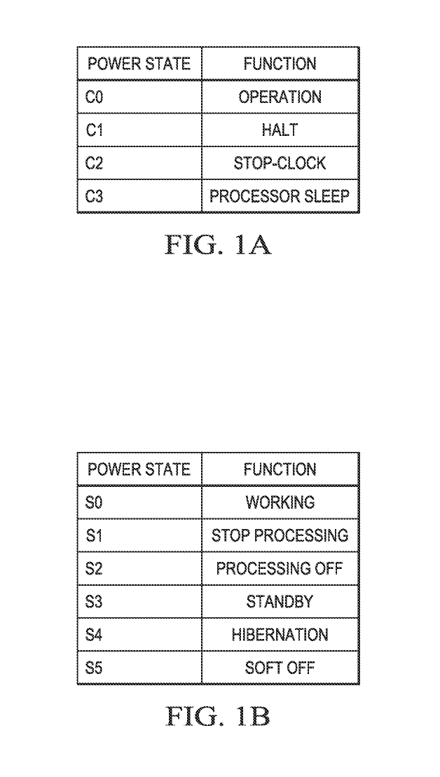

FIG. 1A is a table illustrating processor power states according to at least one example embodiment. The examples of FIG. 1A are merely examples of processor power states, and do not limit the scope of the claims. For example, the number of power states may vary, the designation of power state behavior may vary, and/or the like. In another example, there may be additional power states within and/or between the power states of the example of FIG. 1A.

Even though processor power states described herein relate to the Advanced Control and Power Interface Specification (ACPI) (e.g., Version 5.0 released Dec. 6, 2011), it should be understood that the ACPI is merely an example of a power management scheme that may be utilized to manage power in a processor or a system. Therefore, direct references to specific elements of the ACPI Specification do not limit the claims, unless such specific elements are expressly incorporated into the claims. Moreover, any prior version of the ACPI Specification would also be applicable to the present disclosure.

Processor power may be managed by placing the processor into power states that influence the operation of the processor such that the power consumption of the processor differs across different power states. There may be a tradeoff associated with each power state between performance and power savings. For example, higher power saving power states may be associated with a longer delay in placing the processor into a state that allows for execution of instructions. A power state is a concept used to identify a behavioral profile of a component or system. A processor power state is a concept used to identify a behavioral profile of a processor.

The table of FIG. 1A lists processor power states in descending order of performance. Processor power states, for example under the ACPI standard, may be referred to as C-level states. Power state C0 is associated with the processor executing instructions. Power state C0 may be associated with absence of power or thermal savings. Power state C0 may be referred to as an operation mode. Power state C1 may be associated with a power saving state for which software components are not expected to take recovery latency into account. Power state C1 may involve retaining a clock signal to the processor, but involving the processor abstaining from execution of instructions. Power state C1 may be referred to as a halt mode. Power state C2 may be associated with a power saving state for which software components may benefit from taking recovery latency into account. For example, the software component may consult a register, a variable, a predetermined value, and/or the like, to make a determination regarding entry into power state C2. Power state C2 may involve terminating a clock signal to the processor as well as the processor abstaining from executing instructions. Power state C2 may be referred to as a stop-clock mode. Power State C3 may be associated with a power saving state for which software components may benefit from taking recovery latency into account, but having a greater associated power saving than power state C2 and a longer recovery latency than power state C2. For example, the software component may consult a register, a variable, a predetermined value, and/or the like, to make a determination regarding entry into power state C2. Power state C3 may involve storing register information into memory or abstaining from some cache operations. Power state C3 may be referred to as a processor sleep state.

It should be understood that processor power states may be further divided into sub-states as desired. For example, power state C3 may have sub-states that vary in power savings and recovery latency. In another example, power state C1 may have sub-states that vary in power savings and recovery latency.

Programs may communicate regarding power state by using information indicating power state information. For example, there may be a variable, a message parameter, and/or the like that comprises information that indicates a power state. In addition, there may be a variable, a message parameter, and/or the like, that comprises information indicating a power state limitation. A power state limitation may be a limitation that restricts a power state that the processor is allowed to enter. For example, a power state limitation may be a limitation that the power state should be no greater than C2, thus precluding power state C3. In at least one example embodiment, the power state limitation may apply to the ACPI standard. In such an embodiment, the power state limitation may constrain C-level settings.

FIG. 1B is a table illustrating sleep power states according to at least one example embodiment. The examples of FIG. 1B are merely examples of sleep power states, and do not limit the scope of the claims. For example, the number of power states may vary, the designation of power state behavior may vary, and/or the like. In another example, there may be additional power states within and/or between the power states of the example of FIG. 1B.

Even though sleep power states described herein relate to the Advanced Control and Power Interface specification (ACPI), it should be understood that the ACPI is merely an example of a power management scheme that may be utilized to manage power in a processor or a system. Therefore, direct references to specific elements of the ACPI do not limit the claims, unless such specific elements are expressly incorporated into the claims.

System power may be managed by placing the system, and/or one or more parts of the system, into power states that influence the operation of the system such that the power consumption of the system differs across different power states. There may be a tradeoff associated with each power state between performance and power savings. For example, higher power saving power states may be associated with a longer delay in placing the system into a state that allows for execution of instructions. A power state is a concept used to identify a behavioral profile of a component or system. A sleep power state is a concept used to identify a behavioral profile of a system.

The table of FIG. 1B lists sleep power states in descending order of performance. System power states, under the ACPI standard, may be referred to as S-level states. Power state S0 is associated with normal operation of the system. Power state S0 may be associated with absence of power or thermal savings. Power state S0 may be referred to as a working mode. Power States S1-S4 relate to various depths of sleep-based power saving. Power state S1 may be associated with a power saving state for which instruction execution may restart with the lowest recovery latency of the S1-S4 states, but with the lowest power saving of the S1-S4 states. Power state S1 may involve flushing processor caches, terminating processor execution, retaining power to RAM and the processor, and reducing power to devices in the system that fail to indicate a need to avoid reduced power. Power state S1 may be referred to as a stop-processing mode. Power state S2 may be associated with a power saving state for which instruction execution may restart with a longer recovery latency than the S1 state, but with the greater power saving than the S1 state. Beyond the power saving actions of S1, power state S2 may involve powering off the processor and flushing the dirty cache to RAM. Power state S2 may be referred to as a processing-off mode. Power state S3 may be associated with a power saving state for which instruction execution may restart with a longer recovery latency than the S2 state, but with the greater power saving than the S2 state. Beyond the power saving actions of S2, power state S3 may involve powering off all components except a real time clock and memory, which may operate at a reduced power level. Power state S3 may be referred to as a standby mode. Power state S4 may be associated with a power saving state for which instruction execution may restart with a longer recovery latency than the S3 state, but with the greater power saving than the S3 state. Beyond the power saving actions of S3, power state S4 may involve storing volatile memory contents to non-volatile memory and terminating power to memory. Power state S4 may be referred to as a hibernation mode. Power state S5 may be associated with a power saving state that avoids saving system context information. Power state S5 may be terminated by pressing a power button. Power state S5 may be referred to as a soft-off mode.

It should be understood that power states may be further divided into sub-states as desired. For example, power state C0 may have sub-states that vary in power savings and recovery latency.

Programs may communicate regarding system power state by using information indicating power state information. For example, there may be a variable, a message parameter, and/or the like that comprises information that indicates a power state. In addition, there may be a variable, a message parameter, and/or the like, that comprises information indicating a power state limitation. A power state limitation may be a limitation that restricts a power state that the system is allowed to enter. For example, a power state limitation may be a limitation that the power state should be no greater than S2, thus precluding power states S3, S4, and S5. In at least one example embodiment, the power state limitation may apply to the ACPI standard. In such an embodiment, the power state limitation may constrain S-level settings.

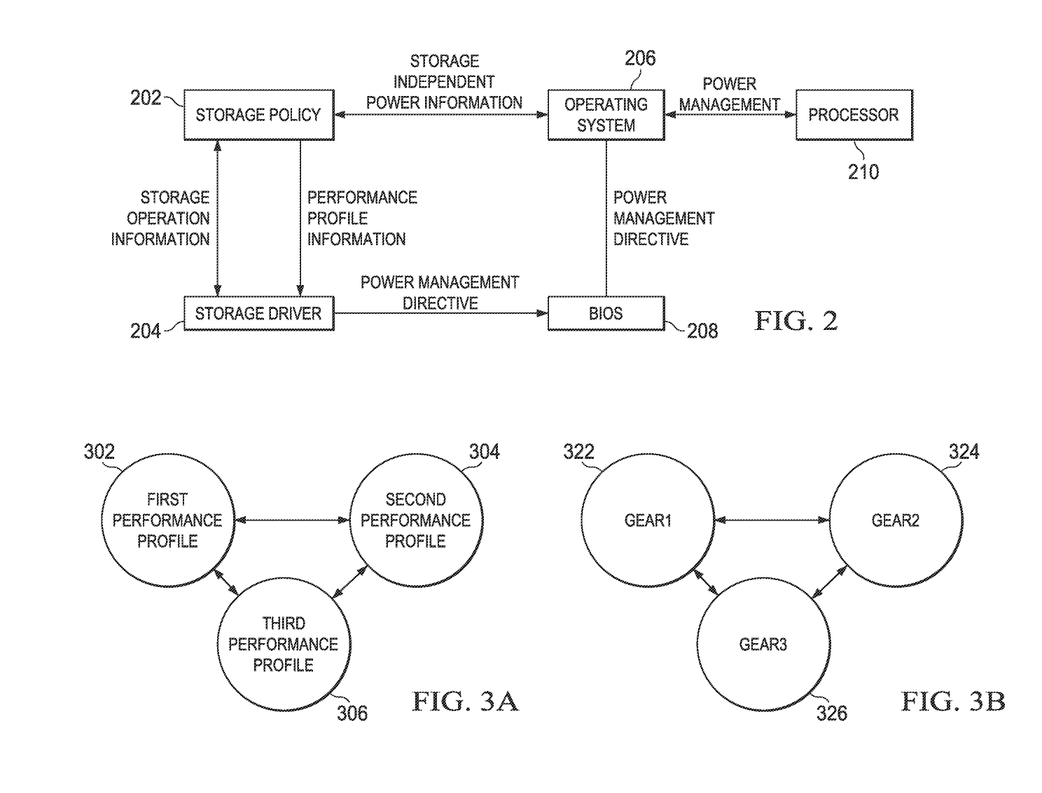

FIG. 2 is a block diagram illustrating software component interaction of an apparatus according to at least one example embodiment. The examples of FIG. 2 are merely examples of software component interaction, and do not limit the scope of the claims. For example, operations attributed to a software component may vary, number of software components may vary, composition of a software component may vary, and/or the like. For example, in some example embodiments, operations attributable to one software component of the example of FIG. 2 may be allocated to one or more other software components.

In at least one example embodiment, the apparatus comprises storage policy 202. Storage policy 202 may be referred to as Dynamic Storage Acceleration Technology. Storage policy 202 may evaluate one or more factors to influence one or more power saving and/or performance determinations.

Storage policy 202 may be in communication with storage driver 204. Storage driver 204 may be a Rapid Storage Technology driver. In at least one example embodiment, storage driver 204 controls operation of one or more storage device, such as a hard drive. A hard drive may comprise one or more hard disk drive, solid state drive, optical disk drive, etc. Operations controlled by storage driver 204 may be referred to as storage drive operations. A storage drive operation may relate to reading information to a storage device and/or writing information to a storage device. Such reading and or writing operations may be referred to as an IO operation. Storage driver 204 may control the storage device by tracking pending storage drive operations. For example, there may be more than one storage drive operation to be performed and/or completed by way of storage driver 204. In such an example, storage driver 204 may track the storage drive operations as pending storage drive operations. Storage driver 204 may use a queue to track storage drive operations such that the queue comprises information indicating at least one pending storage drive operation. Storage driver 204 may provide power management control for the storage device. For example, storage driver 204 may set voltage regulation, power up, and/or latency tolerance for the storage device. For example, if a pending storage operation does not require media access, the storage device may be powered up in standby mode, but if the pending storage operation does require media access, the storage device may be powered up in active mode. Storage driver 204 may control latency tolerance of the storage device by increasing latency tolerance as time elapses without any pending storage operation. For example, if a first time threshold expires without an intervening storage operation, latency tolerance of the storage device may be increased. In such an example, if a greater, second time threshold expires without an intervening storage operation, latency tolerance of the storage device may be further increased. Storage driver 204 may control voltage regulation of the storage device by increasing latency tolerance as time elapses without any pending storage operation. For example, if a first time threshold expires without an intervening storage operation, light load signaling of the storage device may be initiated. In such an example, if a greater, second time threshold expires without an intervening storage operation, the storage device voltage regulators may be powered off.

In at least one example embodiment, storage policy 202 may control the power management of storage driver 204. For example, storage policy 202 may determine the first and second threshold discussed above in relation to pending storage operations. Storage policy 202 may influence power management of storage driver 204 by providing performance profile information to storage driver 204. The performance profile information comprises information representing at least one aspect of a performance profile. A performance profile is one or more regulation regarding power savings and/or latency. The performance profile comprises information that relates to a balance between storage drive operation latency and power consumption. The performance profile may comprise storage drive power regulation information, such as storage drive voltage regulation, a latency directive, and/or the like. A latency directive can include any information communicating regulation of latency. For example, a latency directive may be information indicating low latency.

In some circumstances, it may be desirable for storage policy 202 to influence power management regarding components beyond the storage device. For example, if there is a pending storage operation, it may be undesirable for the processor and/or the system to enter a power saving mode associated with a recovery latency that may cause the completion of the storage operation to be delayed by recovery from the power saving mode. In such an example, the processor may be unable to execute instructions resulting from completion of a storage operation until completion of power saving recovery. Therefore, it may be desirable that the performance profile comprise information regulating power state. In at least one example embodiment, the performance profile comprises information indicating a power state limitation. The power state limitation may relate to a processor power state. For example, the power state limitation may constrain a processor power state. The power state limitation may constrain the processor power state by comprising information indicating a threshold processor power state that should not be exceeded. For example, the power state limitation may constrain a C-level setting such that the power state limitation indicates a threshold C-level power state which should not be surpassed. This threshold processor power state limitation may indicate a maximum processor power state limitation. The power state limitation may constrain the sleep power state by comprising information indicating a threshold sleep power state that should not be exceeded. For example, the sleep state limitation may constrain an S-level setting such that the power state limitation indicates a threshold S-level power state which should not be surpassed. This threshold sleep power state limitation may indicate a maximum sleep power state limitation. In an example embodiment, the performance profile may comprise information corresponding to preclusion of a power saving feature. For example, the performance profile may comprise a directive to preclude a power saving feature. In another example, the performance profile may comprise information setting a power state threshold that precludes invocation of a power saving power state. In such an example, the performance profile may comprise information indicating a processor power state threshold of C0, a sleep power state of S0, and/or the like.

In at least one example embodiment, storage policy 202 receives storage operation information from storage driver 204. The storage operation information may indicate one or more pending storage drive operations. For example, the storage operation information may indicate a quantity of pending storage operations. The storage operation information may relate to allowable latency for a pending storage operation. For example, a storage operation associated with media access may have a low allowable latency. In another example, a storage operation associated with non-media access may have a high allowable latency in comparison to the media access storage operation. The storage operation information may indicate a latency tolerance for pending storage drive operations. For example, a storage operation associated with media access may have a low latency tolerance. In such an example, the storage operation information may indicate that increased storage operations latency is unfavorable. In another example, a storage operation associated with non-media access may have a high latency tolerance in comparison to the media access storage operation. In such an example, the storage operation information may indicate that increased storage operation latency is acceptable. In at least one embodiment, storage driver 204 may track elapsed time associated with a storage operation, similar as described regarding storage policy 202. Under such circumstances, the storage operation information may comprise information indicating an elapsed time associated with a storage drive operation, such as an elapsed time relating to a duration after performance of a storage drive operation. In an example embodiment, receiving the storage operation information comprises receiving an indication that a timer event has occurred.

Storage policy 202 may receive storage independent power information. The storage independent power information may be received from operating system 206, from a user interface, and/or the like. Storage independent power information comprises information indicating one or more factors that may be pertinent to storage policy power management, but are not directly related to storage. For example, the storage independent power information may comprise a user directive indicator. The user directive indicator may indicate a directive that is modifiable by a user. The directive may be modified by a user by the user selecting an interface item associated, directly or indirectly, with the directive. For example, the user directive may comprise a power scheme indicator. The power scheme indicator relates to a power scheme of an operating system, such as Windows, Linux, etc. For example, the power scheme indicator may indicate a high performance mode, a balanced mode, a power saver mode, and/or the like.

The storage independent power information may comprise any suitable information regarding a power source. The power source relates to the supply of power that the apparatus comprising storage policy 202 is utilizing. For example, information regarding a power source may indicate an internal power source, an external power source, a battery power source, a power source connected to a power plug, a direct current power source, an alternating current power source, and/or the like.

Storage policy 202 may cause setting of at least one power management directive that corresponds with the performance profile. The power management directive may comprise information that communicates to a software component outside of storage policy 202, at least a part of the performance profile information. For example the power management directive may indicate preclusion of a power state, such as sleep power state. In an example embodiment, causing a setting of the power management directive may comprise communicating the power management directive to operating system 206, to storage driver 204, to bios 208, and/or the like. Causing a setting of the power management directive may comprise remapping at least one power state to an alternative power state. For example, remapping may be performed so that a determination to enter one power state results in entry of a different power state. In such an example, if the power management directive relates to limiting processor power state to C1, processor power states C2 and C3 may be remapped such that when processor power states C2 or C3 are invoked, the resulting processor power state is C1. This remapping may correspond to updating an ACPI table. In at least one example embodiment, operating system 206 may send power management information to the processor. Such power management information may comprise information enabling or disabling a processor power state, such as a C-state.

FIGS. 3A and 3B are diagrams illustrating examples of performance profiles. The examples of FIGS. 3A and 3B are merely examples of performance profiles, and do not limit the scope of the claims. For example, number of possible performance profiles may vary, transition from one performance profile to another may vary, and/or the like.

An apparatus may determine a performance profile based at least in part on the storage operation information and the storage independent power information. The determination may comprise determining a balance between storage drive operation latency and power consumption.

FIG. 3A illustrates at least one example embodiment of performance profiles. The example of FIG. 3A illustrates first performance profile 302, second performance profile 304, and third performance profile 306. The apparatus may determine which performance profile to utilize based, at least in part, on storage operation information and storage independent information.

In the example of FIG. 3A, first performance profile 302 may correspond to at least one of power source information indicating a battery power source, power scheme information indicating power saver mode, or storage information indicating that increased storage operations latency is acceptable, for example by indicating high queue depth. First performance profile 302 may relate to a performance profile that seeks to preserve power at the expense of latency. For example, first performance profile 302 may be absent information corresponding to preclusion of a power saving feature. For example, first performance profile may allow utilization of power saving features without restriction by the first performance profile 302.

In the example of FIG. 3A, second performance profile 304 may correspond to power source information indicating external power source, power scheme information indicating balanced mode, and storage operation information indicating that increased storage operations latency is unfavorable, for example by indicating low queue depth. Second performance profile 304 may relate to a performance profile that seeks to balance latency with power saving. For example, second performance profile 304 may relate to preclusion of power states associated with a latency above a certain threshold. For example, second performance profile 304 may relate to preclusion of processor power state C3, and/or sleep power states S2-S5.

In the example of FIG. 3A, third performance profile 306 may correspond to power source information indicating external power source, power scheme information indicating high performance mode, and storage operation information indicating that increased storage operations latency is unfavorable, for example by indicating low queue depth. Third performance profile 306 may relate to a performance profile that seeks to avoid latency, even at the expense of power saving. For example, third performance profile 306 may relate to preclusion of power states associated with a latency above a certain threshold. For example, third performance profile 306 may preclude a power saving feature relating to at least one of processor C-States or sleep S-States. For example, third performance profile 306 may preclude any C-state other than C0. In another example, third performance profile 306 may preclude any S-state other than S0.

When there is a change in at least one of the storage operation information or the storage independent power information, the apparatus may determine to change the performance profile. For example, the apparatus may change from utilization of first performance profile 302 to utilization of second performance profile 304.

FIG. 3B illustrates performance profiles in terms of latency. The allowed latency associated with a performance profile may be referred to as a Gear to indicate allowable latency. For example performance profile 322 may be referred to as Gear 1, performance profile 324 may be referred to as Gear 2, and performance profile 326 may be referred to as Gear 3. In at least one example embodiment, Gear 1 corresponds to first performance profile 302 of FIG. 3A. In at least one example embodiment, Gear 2 corresponds to second performance profile 304 of FIG. 3A. In at least one example embodiment, Gear 3 corresponds to third performance profile 306 of FIG. 3A. In at least one example embodiment, a Gear 4 performance profile comprises a power state directive indicating disabling CPU states.

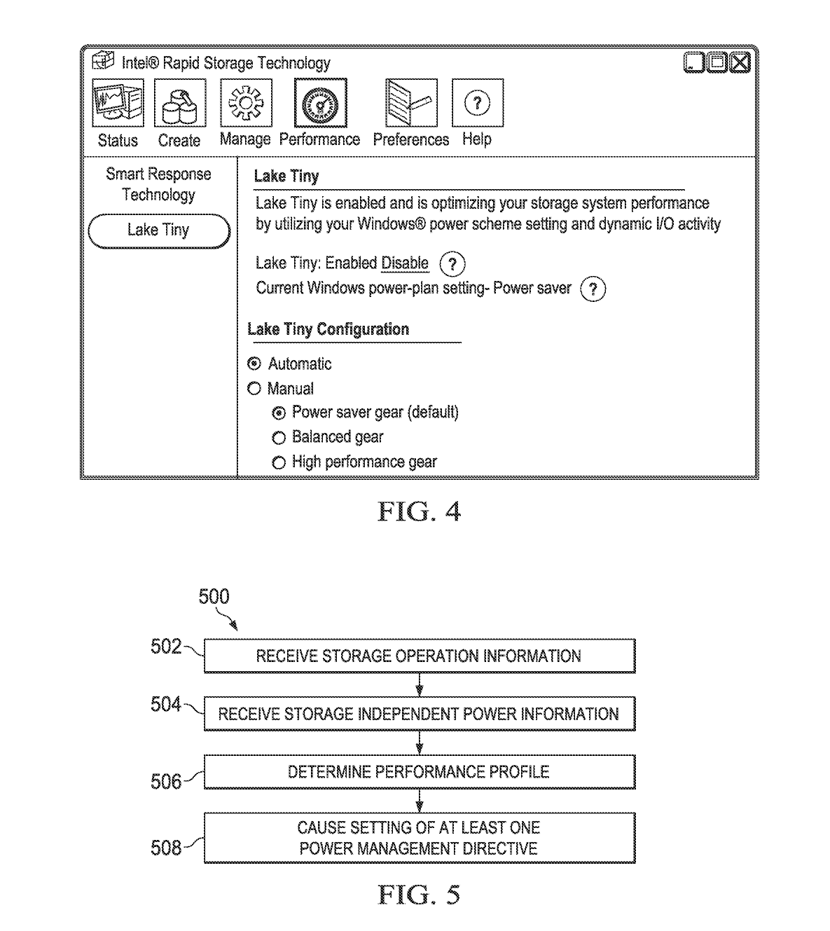

FIG. 4 is a diagram illustrating an example user interface for setting storage independent power information according to at least one example embodiment. The examples of FIG. 4 are merely examples of a user interface for setting storage independent power information, and do not limit the scope of the claims. For example, the types of storage independent power information may vary, the representation of information provided to the user may vary, and/or the like.

There may be some storage independent power information that corresponds to a selection by a user. For example, an option selected by a user from the example interface of the example of FIG. 4 may be referred to as a user directive. Such a user directive may be represented within the storage independent power information by way of a user directive indicator. In at least one example embodiment, a user directive indicator comprised in storage independent power information represents is an indicator that represents a user selection that may pertain to power information. Therefore, a user directive indicator indicates a directive that is modifiable by a user. However, it should be understood that there may be storage independent power information that does not correspond to a directive that is modifiable by a user.

In the example of FIG. 4, the options selectable by a user are labeled by “Lake Tiny Configuration.” The selectable directives shown in FIG. 4 relate to an automation directive. The automation directive may relate to a directive to automatically select a performance profile, similar as described regarding FIG. 3, or to use a selected predefined performance profile. For example, if the user selects “Automatic”, the storage independent power information may comprise an automation directive that indicates automatic operation of performance profile selection, similar as described regarding FIG. 3. If the user selects “Manual” and/or selects power saver gear, balanced gear, or high performance gear, the storage independent power information may comprise an automation directive that indicates preclusion of automatic operation for determination of a performance profile. The indication of preclusion of automatic operation may relate to the automation directive specifying non-automatic operation. Preclusion of automatic operation may relate to preventing the apparatus from automatically determining a performance profile.

Selection of the automatic option may result in a user directive indicator indicating an automation directive that indicates that automatic determination of performance profile should be performed. The options provided to the user for power saver gear, balanced gear, or high performance gear, may be referred to as predetermined performance profiles. If the user selects one of the options associated with a predetermined performance profile, the automation directive may specify the predetermined performance profile to be used. For example, if the automation directive specifies “Gear2”, the Gear 2 performance profile may be determined absent other considerations. Therefore, an automation directive specifying a predetermined performance profile may result in the user manually selecting the performance profile to be determined by storage policy 202.

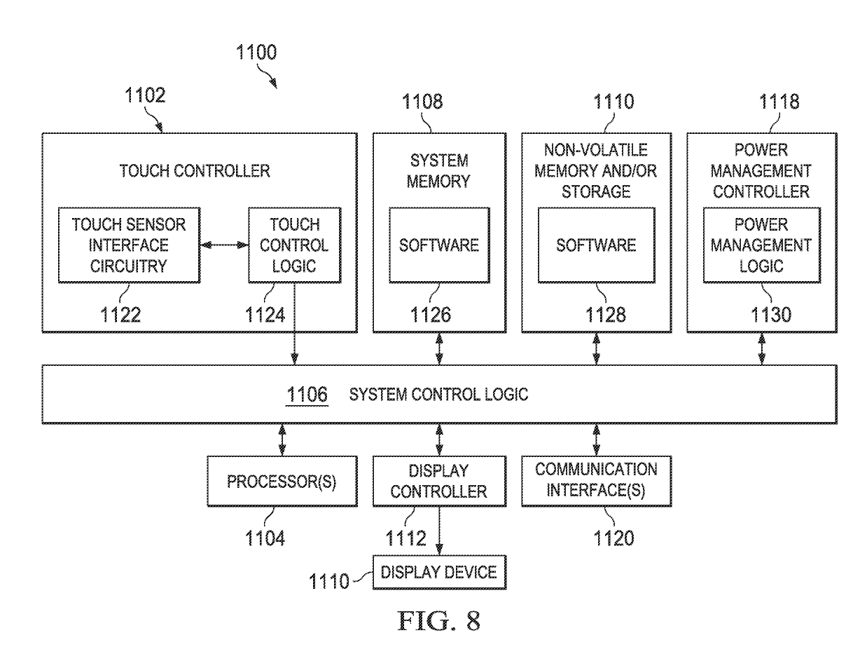

FIG. 5 is a flow diagram showing a set of operations for providing for power savings according to at least one example embodiment. An apparatus, for example system 1100 of FIG. 8 or a portion thereof, may utilize the set of operations 500. The apparatus may comprise means, including, for example processor 1104 of FIG. 8, for performing the operations of FIG. 5. In an example embodiment, an apparatus, for example system 1100 of FIG. 8, is transformed by having memory, for example system memory 1108 of FIG. 8, comprising computer code configured to, working with a processor, for example processor 1104 of FIG. 8, cause the apparatus to perform set of operations 500.

At block 502, storage operation information is received. The storage operation information and the receiving of the storage operation information may be similar as described regarding FIG. 2. Additionally or alternatively, storage operation information may be received by being received from a separate device, by retrieving information from one or more memory, and/or the like. At block 504, storage independent power information is received. The storage independent power information and the receiving of the storage independent power information may be similar as described regarding FIG. 2. Additionally or alternatively, storage independent power information may be received by being received from a separate device, by retrieving information from one or more memory, and/or the like. At block 506, a performance profile is determined based, at least in part, on the storage operation information and the storage independent power information. The performance profile may be similar as described regarding FIGS. 2, 3A, and 3B. Determination of the performance profile may be similar as described regarding FIGS. 3A and 3B. At block 508, setting of at least one power management directive is caused. The power management directive and the causing of setting may be similar as described regarding FIG. 2.

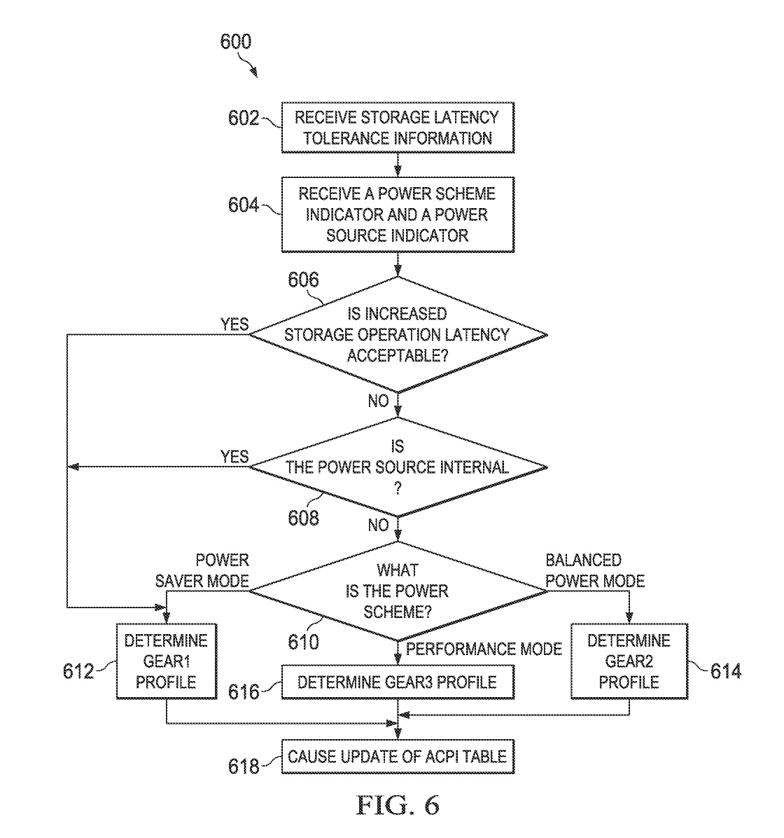

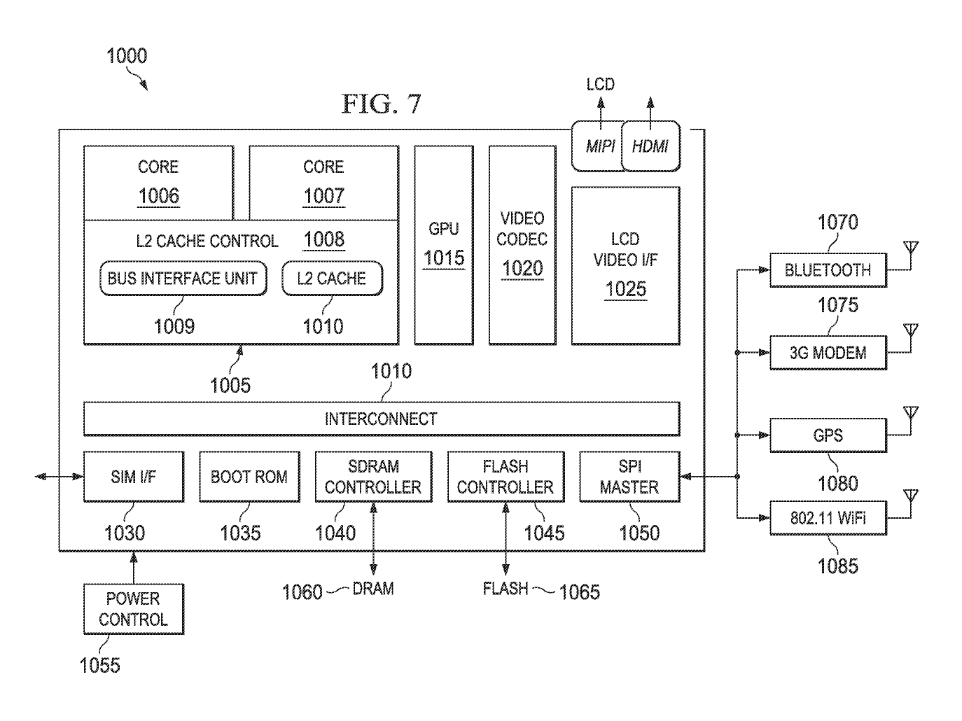

FIG. 6 is another flow diagram showing a set of operations for providing for power savings according to at least one example embodiment. An apparatus, for example system 1100 of FIG. 8 or a portion thereof, may utilize the set of operations 600. The apparatus may comprise means, including, for example processor 1104 of FIG. 8, for performing the operations of FIG. 6. In an example embodiment, an apparatus, for example system 1100 of FIG. 8, is transformed by having memory, for example system memory 1108 of FIG. 8, comprising computer code configured to, working with a processor, for example processor 1104 of FIG. 8, cause the apparatus to perform set of operations 600.

At block 602 storage latency tolerance information is received. The storage latency tolerance information may be similar as described regarding FIG. 2. The receiving of the storage latency tolerance information may be similar as described regarding block 502 of FIG. 5. At block 604, a power scheme indicator and a power source indicator are received. The power scheme indicator and the power source indicator may be similar as described regarding FIG. 2. The receiving of the power scheme indicator and the power source indicator may be similar as described regarding block 504 of FIG. 5.

At block 602, the apparatus determines if increased storage operation latency is acceptable. This determination may be similar as described regarding FIG. 3. If, at block 606, the apparatus determines that increased storage operation latency is acceptable, flow proceeds to block 612. Otherwise, flow proceeds to block 608. At block 608, the apparatus determines whether the power source is internal. If, at block 608, the apparatus determines that the power source is internal, flow proceeds to block 612. Otherwise, flow proceeds to block 610. At block 610, the apparatus evaluates the power scheme. If, at block 610, the power scheme is similar to a power saver mode, flow proceeds to block 612. At block 612, the apparatus determines a performance profile of Gear1, similar as described regarding FIG. 3, which is followed by block 618. If, at block 610, the power scheme is similar to a balanced power mode, flow proceeds to block 614. At block 614, the apparatus determines a performance profile of Gear2, similar as described regarding FIG. 3, which is followed by block 618. If, at block 610, the power scheme is similar to a high performance mode, flow proceeds to block 616. At block 616, the apparatus determines a performance profile of Gear3, similar as described regarding FIG. 3, which is followed by block 618. At block 618, the apparatus causes updating of the ACPI table similar as described regarding FIG. 3.

FIG. 7 is a simplified block diagram associated with an example ARM ecosystem SOC 1000 of the present disclosure. At least one example implementation of the present disclosure includes an integration of the power savings features discussed herein and an ARM component. For example, the example of FIG. 7 can be associated with any ARM core (e.g., A-9, A-15, etc.). Further, the architecture can be part of any type of tablet, smartphone (inclusive of Android™ phones, i-Phones™), i-Pad™, Google Nexus™, Microsoft Surface™, personal computer, server, video processing components, laptop computer (inclusive of any type of notebook), any type of touch-enabled input device, etc.

In this example of FIG. 7, ARM ecosystem SOC 1000 may include multiple cores 1006-1007, an L2 cache control 1008, a bus interface unit 1009, an L2 cache 1010, a graphics processing unit (GPU) 1015, an interconnect 1010, a video codec 1020, and a liquid crystal display (LCD) I/F 1025, which may be associated with mobile industry processor interface (MIPI)/high-definition multimedia interface (HDMI) links that couple to an LDC.

ARM ecosystem SOC 1000 may also include a subscriber identity module (SIM) I/F 1030, a boot read-only memory (ROM) 1035, a synchronous dynamic random access memory (SDRAM) controller 1040, a flash controller 1045, a serial peripheral interface (SPI) master 1050, a suitable power control 1055, a dynamic RAM (DRAM) 1060, and flash 1065. In addition, one or more example embodiment include one or more communication capabilities, interfaces, and features such as instances of Bluetooth 1070, a 3G modem 1075, a global positioning system (GPS) 1080, and an 802.11 WiFi 1085.

In operation, the example of FIG. 7 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe® Flash® Player, Java Platform Standard Edition (Java SE), JavaFX, Linux, Microsoft Windows Embedded, Symbian and Ubuntu, etc.). In at least one example embodiment, the core processor may implement an out-of-order superscalar pipeline with a coupled low-latency level-2 cache.

FIG. 8 is a simplified block diagram illustrating potential electronics and logic that may be associated with any of the power saving operations discussed herein. In at least one example embodiment, system 1100 includes a touch controller 1102, one or more processors 1104, system control logic 1106 coupled to at least one of processor(s) 1104, system memory 1108 coupled to system control logic 1106, non-volatile memory and/or storage device(s) 1110 coupled to system control logic 1106, display controller 1112 coupled to system control logic 1106, display controller 1112 coupled to a display, power management controller 1118 coupled to system control logic 1106, and/or communication interfaces 1120 coupled to system control logic 1106.

System control logic 1106, in at least one embodiment, includes any suitable interface controllers to provide for any suitable interface to at least one processor 1104 and/or to any suitable device or component in communication with system control logic 1106. System control logic 1106, in at least one example embodiment, includes one or more memory controllers to provide an interface to system memory 1108. System memory 1108 may be used to load and store data and/or instructions, for example, for system 1100. System memory 1108, in at least one example embodiment, includes any suitable volatile memory, such as suitable dynamic random access memory (DRAM) for example. System control logic 1106, in at least one example embodiment, includes one or more input/output (I/O) controllers to provide an interface to a display device, touch controller 1102, and non-volatile memory and/or storage device(s) 1110.

Non-volatile memory and/or storage device(s) 1110 may be used to store data and/or instructions, for example within software 1128. Non-volatile memory and/or storage device(s) 1110 may include any suitable non-volatile memory, such as flash memory for example, and/or may include any suitable non-volatile storage device(s), such as one or more hard disc drives (HDDs), one or more compact disc (CD) drives, and/or one or more digital versatile disc (DVD) drives for example.

Power management controller 1118 may include power management logic 1130 configured to control various power management and/or power saving functions disclosed herein or any part thereof. In at least one example embodiment, power management controller 1118 is configured to reduce the power consumption of components or devices of system 1100 that may either be operated at reduced power or turned off when the electronic device is in the closed configuration. For example, in at least one example embodiment, when the electronic device is in a closed configuration, power management controller 1118 performs one or more of the following: power down the unused portion of the display and/or any backlight associated therewith; allow one or more of processor(s) 1104 to go to a lower power state if less computing power is required in the closed configuration; and shutdown any devices and/or components, such as keyboard 108, that are unused when an electronic device is in the closed configuration.

Communications interface(s) 1120 may provide an interface for system 1100 to communicate over one or more networks and/or with any other suitable device. Communications interface(s) 1120 may include any suitable hardware and/or firmware. Communications interface(s) 1120, in at least one example embodiment, may include, for example, a network adapter, a wireless network adapter, a telephone modem, and/or a wireless modem.

System control logic 1106, in at least one example embodiment, includes one or more input/output (I/O) controllers to provide an interface to any suitable input/output device(s) such as, for example, an audio device to help convert sound into corresponding digital signals and/or to help convert digital signals into corresponding sound, a camera, a camcorder, a printer, and/or a scanner.

For at least one example embodiment, at least one processor 1104 may be packaged together with logic for one or more controllers of system control logic 1106. In at least one example embodiment, at least one processor 1104 may be packaged together with logic for one or more controllers of system control logic 1106 to form a System in Package (SiP). In at least one example embodiment, at least one processor 1104 may be integrated on the same die with logic for one or more controllers of system control logic 1106. For at least one example embodiment, at least one processor 1104 may be integrated on the same die with logic for one or more controllers of system control logic 1106 to form a System on Chip (SoC).

For touch control, touch controller 1102 may include touch sensor interface circuitry 1122 and touch control logic 1124. Touch sensor interface circuitry 1122 may be coupled to detect touch input over a first touch surface layer and a second touch surface layer of display 11 (i.e., display device 1110). Touch sensor interface circuitry 1122 may include any suitable circuitry that may depend, for example, at least in part on the touch-sensitive technology used for a touch input device. Touch sensor interface circuitry 1122, in one embodiment, may support any suitable multi-touch technology. Touch sensor interface circuitry 1122, in at least one embodiment, includes any suitable circuitry to convert analog signals corresponding to a first touch surface layer and a second surface layer into any suitable digital touch input data. Suitable digital touch input data for one embodiment may include, for example, touch location or coordinate data.

Touch control logic 1124 may be coupled to help control touch sensor interface circuitry 1122 in any suitable manner to detect touch input over a first touch surface layer and a second touch surface layer. Touch control logic 1124 for at least one example embodiment may also be coupled to output in any suitable manner digital touch input data corresponding to touch input detected by touch sensor interface circuitry 1122. Touch control logic 1124 may be implemented using any suitable logic, including any suitable hardware, firmware, and/or software logic (e.g., non-transitory tangible media), that may depend, for example, at least in part on the circuitry used for touch sensor interface circuitry 1122. Touch control logic 1124 for one embodiment may support any suitable multi-touch technology.

Touch control logic 1124 may be coupled to output digital touch input data to system control logic 1106 and/or at least one processor 1104 for processing. At least one processor 1104 for one embodiment may execute any suitable software to process digital touch input data output from touch control logic 1124. Suitable software may include, for example, any suitable driver software and/or any suitable application software. As illustrated in FIG. 11, system memory 1108 may store suitable software 1126 and/or non-volatile memory and/or storage device(s).

Note that in some example implementations, the functions outlined herein may be implemented in conjunction with logic that is encoded in one or more tangible, non-transitory media (e.g., embedded logic provided in an application-specific integrated circuit (ASIC), in digital signal processor (DSP) instructions, software [potentially inclusive of object code and source code] to be executed by a processor, or other similar machine, etc.). In some of these instances, memory elements can store data used for the operations described herein. This includes the memory elements being able to store software, logic, code, or processor instructions that are executed to carry out the activities described herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), a DSP, an erasable programmable read only memory (EPROM), electrically erasable programmable read-only memory (EEPROM)) or an ASIC that includes digital logic, software, code, electronic instructions, or any suitable combination thereof.

Note that with the examples provided above, as well as numerous other examples provided herein, interaction may be described in terms of layers, protocols, interfaces, spaces, and environments more generally. However, this has been done for purposes of clarity and example only. In certain cases, it may be easier to describe one or more of the functionalities of a given set of flows by only referencing a limited number of components. It should be appreciated that the architectures discussed herein (and its teachings) are readily scalable and can accommodate a large number of components, as well as more complicated/sophisticated arrangements and configurations. Accordingly, the examples provided should not limit the scope or inhibit the broad teachings of the present disclosure, as potentially applied to a myriad of other architectures.

It is also important to note that the blocks in the flow diagrams illustrate only some of the possible signaling scenarios and patterns that may be executed by, or within, the circuits discussed herein. Some of these blocks may be deleted or removed where appropriate, or these steps may be modified or changed considerably without departing from the scope of teachings provided herein. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by the present disclosure in that any suitable arrangements, chronologies, configurations, and timing mechanisms may be provided without departing from the teachings provided herein.

It is also imperative to note that all of the Specifications, protocols, and relationships outlined herein (e.g., specific commands, timing intervals, supporting ancillary components, etc.) have only been offered for purposes of example and teaching only. Each of these data may be varied considerably without departing from the spirit of the present disclosure, or the scope of the appended claims. The specifications apply to many varying and non-limiting examples and, accordingly, they should be construed as such. In the foregoing description, example embodiments have been described. Various modifications and changes may be made to such embodiments without departing from the scope of the appended claims. The description and drawings are, accordingly, to be regarded in an illustrative rather than a restrictive sense.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the Specification, to limit this disclosure in any way that is not otherwise reflected in the appended claims.

### EXAMPLE EMBODIMENT IMPLEMENTATIONS

One particular example implementation may include an apparatus that includes a means for receiving storage operation information indicating one or more storage drive operations; means for receiving storage independent power information; means for determining, by a processor, a performance profile based at least in part on the storage operation information and the storage independent power information; and means for causing a setting of at least one power management directive that corresponds with the performance profile.

What is claimed is:

1. An apparatus comprising at least one processor and at least one memory, the at least one memory comprising instructions that, when executed by the processor, cause the apparatus to:
receive storage operation information that is to indicate one or more storage drive operations;
receive storage independent power information;
determine a performance profile based at least in part on the storage operation information and the storage independent power information; and
cause setting of at least one power management directive that is to correspond with the performance profile.

2. The apparatus of claim 1, wherein the storage operation information is to indicate one or more pending storage drive operations.

3. The apparatus of claim 1, wherein the storage independent power information comprises a power scheme indicator.

4. The apparatus of claim 1, wherein the storage independent power information is to indicate an automation directive.

5. The apparatus of claim 1, wherein the storage independent power information comprises information regarding a power source.

6. The apparatus of claim 1, wherein the performance profile comprises information that is to indicate a power state limitation.

7. The apparatus of claim 1, wherein the performance profile comprises information corresponding to preclusion of a power saving feature.

8. The apparatus of claim 1, wherein the storage operation information is to indicate a latency tolerance for pending storage drive operations, and wherein the storage independent power information comprises a power scheme indicator and a power source indicator, the apparatus being further configured to:
determine a first performance profile based, at least in part, on one or more of the power source indicator and the power source indicator.

9. A method for managing power and performance of a processing apparatus, comprising:
receiving storage operation information indicating one or more storage drive operations;
receiving storage independent power information;
determining, by a processor, a performance profile based at least in part on the storage operation information and the storage independent power information; and
causing a setting of at least one power management directive that is to correspond with the performance profile.

10. The method of claim 9, wherein the storage operation information indicates one or more pending storage drive operations.

11. The method of claim 9, wherein the storage independent power information comprises a power scheme indicator for a storage device.

12. The method of claim 9, wherein the storage independent power information is to indicate an automation directive.

13. The method of claim 9, wherein the storage independent power information comprises information regarding a power source.

14. The method of claim 9, wherein the performance profile comprises information that is to indicate a power state limitation.

15. The method of claim 9, wherein the performance profile comprises information corresponding to preclusion of a power saving feature.

16. The method of claim 9, wherein the storage operation information is to indicate a latency tolerance for pending storage drive operations, and wherein the storage independent power information comprises a power scheme indicator and a power source indicator, the method further comprising:
determining a first performance profile based, at least in part, on one or more of the power source indicator and the power source indicator.

17. A non-transitory computer readable medium comprising instructions that, when executed by a processor, cause an apparatus to:
receive storage operation information that is to indicate one or more storage drive operations;
receive storage independent power information;
determine a performance profile based at least in part on the storage operation information and the storage independent power information; and
cause setting of at least one power management directive that is to correspond with the performance profile.

18. The computer readable medium of claim 17, wherein the storage operation information is to indicate one or more pending storage drive operations.

19. The computer readable medium of claim 17, wherein the storage independent power information comprises a power scheme indicator.

20. The computer readable medium of claim 17, wherein the storage independent power information is to indicate an automation directive.

21. The computer readable medium of claim 17, wherein the storage independent power information comprises information regarding a power source.

22. The computer readable medium of claim 17, wherein the performance profile comprises information will limitation.

23. The computer readable medium of claim 17, wherein the performance profile comprises information corresponding to preclusion of a power saving feature.

24. The computer readable medium of claim 17, wherein the storage operation information is to indicate a latency tolerance for pending storage drive operations, and wherein the storage independent power information comprises a power scheme indicator and a power source indicator, wherein instructions further cause the apparatus to:
determine a first performance profile based, at least in part, on one or more of the power source indicator and the power source indicator.

25. An apparatus, comprising:
means for receiving storage operation information that is to indicate one or more storage drive operations;
means for receiving storage independent power information;
means for determining, by a processor, a performance profile based at least in part on the storage operation information and the storage independent power information; and
means for causing a setting of at least one power management directive that is to correspond with the performance profile.

26. The apparatus of claim 25, wherein the storage operation information is to indicate one or more pending storage drive operations.

27. The apparatus of claim 25, wherein the storage independent power information comprises a power scheme indicator.
